(19) United States
(12) Patent Application Publication
(10) Pub. No.: US 2026/0143492 A1
(43) Pub. Date: May 21, 2026

(54) METHODS AND SYSTEMS FOR ENHANCEMENT OF CODEBOOK BASED UPLINK OR PHYSICAL UPLINK SHARED CHANNEL TRANSMISSION

(71) Applicant: Apple Inc., Cupertino, CA (US)

(72) Inventors: Haitong Sun, Cupertino, CA (US); Wei Zeng, Saratoga, CA (US); Jie Cui, San Jose, CA (US); Dawei Zhang, Saratoga, CA (US); Oghenekome Oteri, San Diego, CA (US); Sigen Ye, Whitehouse Station, NJ (US); Huaning Niu, San Jose, CA (US); Xiang Chen, San Diego, CA (US)

(21) Appl. No.: 19/123,366

(22) PCT Filed: Oct. 26, 2023
(86) PCT No.: PCT/US2023/036058

§ 371 Date: Apr. 22, 2025

Related U.S. Application Data
(60) Provisional application No. 63/422,281, filed on Nov. 3, 2022.

(51) Int. Cl. H04W 72/21; H04B 7/06

(52) U.S. Cl. CPC H04W 72/21; H04B 7/0639

(57) ABSTRACT

A user equipment (UE) includes a transceiver associated with a set of antenna ports, and a processor configured to transmit, to a network device and via the transceiver, a UE capability corresponding to a coherency mode of a codebook based physical uplink shared channel (PUSCH) operation. The processor is configured to transmit, to the network device and via the transceiver, in accordance with the UE capability corresponding to the coherency mode of the codebook based PUSCH operation, an indication of an antenna architecture of the UE, the antenna architecture based at least partly on the set of antenna ports, and receive, from the network device and via the transceiver, an uplink (UL) transmit precoding matrix indicator (TPMI) codebook for the codebook based PUSCH operation in accordance with the antenna architecture of the UE indicated to the network device.

### CROSS-REFERENCE TO RELATED APPLICATION

This Patent Cooperation Treaty patent application claims priority to U.S. Provisional Patent Application No. 63/422,281, filed Nov. 3, 2022, and titled “Methods and Systems for Enhancement of Codebook Based Uplink or Physical Uplink Shared Channel Transmission,” the contents of which are incorporated herein by reference in its entirety.

### TECHNICAL FIELD

This application relates generally to wireless communication systems, including methods and systems for enhancements of codebook based coherent uplink (UL) or physical uplink shared channel (PUSCH) transmission using a set of antenna ports.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 shows various examples of an antenna architecture, according to embodiments described herein.

FIG. 3 shows an example method of wireless communication performed by a user equipment (UE), according to embodiments described herein.

FIG. 4 shows an example method of wireless communication performed by a network device, according to embodiments described herein.

FIG. 5 illustrates an example architecture of a wireless communication system, according to embodiments disclosed herein.

FIG. 6 illustrates a system for performing signaling between a wireless device and a network device, according to embodiments disclosed herein.

### DETAILED DESCRIPTION

Various embodiments related to enhancement of codebook based uplink (UL) or physical uplink shared channel (PUSCH) transmission, and in particular, enhancements related to a transmit precoding matrix indicator (TPMI) for codebook PUSCH transmission, to enable PUSCH transmission using eight (8) transmitters (Tx) while supporting four (4) or more layers per user equipment (UE) are described.

In some embodiments, for 5G or 5G new radio (5G NR), UL (or PUSCH) transmission via multi-input multi-output (MIMO) antenna architecture supports two different modes-a codebook based PUSCH operation, and a noncodebook based PUSCH operation. For the codebook based PUSCH operation, a transmit precoding matrix indicator (TPMI) and a number of layers corresponding to the PUSCH operations may be indicated in a “precoding information and a number of layers” field of downlink control information (DCI) used for scheduling the PUSCH operation. By way of example, a possible value for the TPMI may be hardcoded, or may be a fixed value, as specified in 3^{rd} Generation Partnership Project (3GPP) Technical Specification (TS) 38.211. For the noncodebook based PUSCH operation, a TPMI and a number of layers corresponding to the PUSCH operation may be indicated using a sounding reference signal (SRS) resource indicator (SRI) field of downlink control information (DCI) used for scheduling the PUSCH operation.

In some embodiments, the codebook based UL (or PUSCH) operation via MIMO antenna architecture may support three different coherency modes-non-coherent, partial-coherent, and full-coherent. A subset of codebook supported for partial-coherent mode is “partialAndNonCoherent,” and a subset of codebook supported for full-coherent mode is “fullyAndPartialAndNonCoherent.” Currently, the codebook based UL (or PUSCH) operation via MIMO antenna architecture supports PUSCH operation using a maximum of four Tx and a maximum of four layers.

Various embodiments, in the present disclosure, enable the codebook based UL (or PUSCH) operation via MIMO antenna architecture to support PUSCH operation using at least 8 Tx (or antenna ports) and 4 or more layers per UE. As described above, various embodiments describe a TPMI for a codebook based coherent PUSCH operation using at least 8 antenna ports. Currently, a TPMI for a codebook based coherent PUSCH operation supports only up to four antenna ports.

In some embodiments, a TPMI for at least 8 Tx, for a codebook based coherent PUSCH operation, may be based on an antenna architecture of a UE, and may be transmitted by the UE as a UE capability. Additionally, or alternatively, the TPMI for at least 8 Tx, for the codebook based coherent PUSCH operation, may be based on a Type I downlink (DL) codebook. Accordingly, a UE may apply a phase or amplitude coefficient as specified by a network device (located in a radio access network (RAN) or a core network (CN)), for each layer of PUSCH, to each of at least 8 antenna ports for a codebook based coherent PUSCH operation. Further enhancements corresponding to reducing an overhead associated with an indication of the UL TPMI codebook are also described in the present disclosure. The present disclosure describes embodiments using 8 antenna ports, but embodiments described herein may also be applied to a UE having more than 8 antenna ports or less than 8 antenna ports (but more than the four antenna ports currently supported in 5G or 5G NR).

Reference will now be made in detail to representative embodiments/aspects illustrated in the accompanying drawings. The following description is not intended to limit the embodiments to one preferred embodiment. On the contrary, it is intended to cover alternatives, combinations, modifications, and equivalents as can be included within the spirit and scope of the described embodiments as defined by the appended claims.

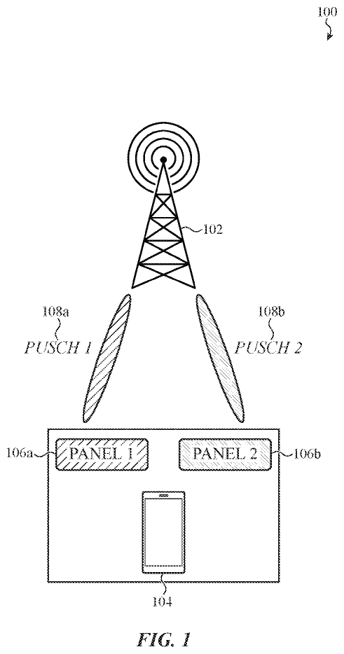

FIG. 1 shows an example wireless communication system, according to embodiments described herein. As shown in FIG. 1, a wireless communication system 100 may include a network device 102 and a user equipment (UE) 104. The UE 104 may be communicatively coupled with the network device 102, to transmit data in an uplink (UL) direction. For example, the UE may make a PUSCH transmission, shown as PUSCH 1 108a and PUSCH 2 108b, via a first antenna panel 106a and a second antenna panel 106b of the UE 104. The UE 104 may also receive data in a downlink (DL) direction using the first antenna panel 106a and the second antenna panel 106b.

In some embodiments, the network device 102 may be eNodeB (eNB), a gNodeB (gNB), or an access point (AP) in a radio access network (RAN) and may support one or more radio access technologies, such as 4G, 5G new radio (5G NR (or 5G)), 6G, and so on. The UE 104 may be a phone, a smart phone, a tablet, a smartwatch, an Internet-of-Things (IoT), a vehicle, and so on. A reference to a user equipment (UE) in the present disclosure is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

As described herein, in some embodiments, a codebook based coherent PUSCH operation is performed via a set of antenna ports. The set of antenna ports may include more than 4 antenna ports (e.g., 8 antenna ports). An antenna architecture describing the set of antenna ports may be presented as a tuple of (N_{g}, N₁, N₂). N_{g}. a first parameter, may correspond to a number of antenna port groups, N₁. a second parameter, may correspond to a number of antenna locations in a vertical direction, and N₂, a third parameter, may correspond to a number of antenna locations in a horizontal direction. Each antenna port may have 1-to-1 or 1-to-N mapping with physical antenna elements, where N is more than 1. In some embodiments, and by way of a non-limiting example, a value of N may be 2, as each antenna port may include vertically polarized and horizontally polarized antenna elements.

By way of a non-limiting example, each antenna port group, or one or more antenna groups, of the number of antenna port groups presented by N_{g} may have the same uniform linear antenna (ULA) structure. Further, a distance between two adjacent antenna port groups may be the same or different. A nature of the distance between the two adjacent antenna port groups may be arbitrarily selected. For example, each antenna location presented by N₁ and/or N₂ may include cross polarized antenna elements. Cross polarization of the antenna elements may be made by vertical polarization and/or horizontal polarization. Further, each antenna location presented by N₁ (if N₁≥2) may be at an equal vertical distance, for example, a distance d1, from another adjacent antenna location in the vertical direction, and each antenna location presented by N₂ (if N₂≥2) may be at an equal horizontal distance, for example, a distance d2, from another adjacent antenna location in the horizontal direction. By way of a non-limiting example, the distance d1 may be the same as the distance d2, or the distance d1 may be different from the distance d2.

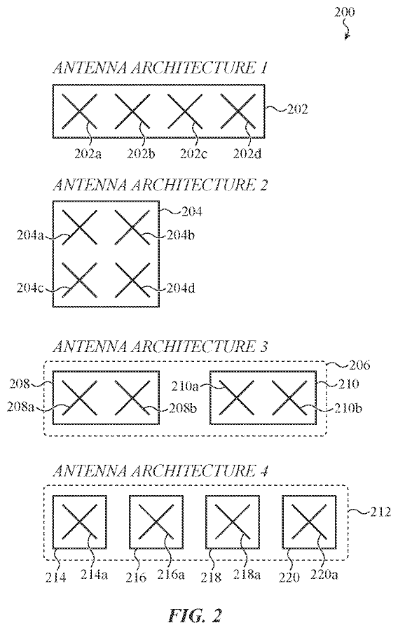

Various examples of an antenna architecture, which may be presented using the tuple of (N_{g}, N₁, N₂), are shown in FIG. 2. In a diagram 200, four different antenna architectures are shown, which may correspond with antenna architectures that are required to be supported in some embodiments, while other antenna architectures are also possible. A first antenna architecture 202 includes four antenna locations 202a, 202b, 202c, and 202d, in a single antenna panel. The first antenna architecture 202 may be presented using N_{g}=1, N₁=4, and N₂=1, such as (1, 4, 1). A second antenna architecture 204 includes four antenna locations 204a, 204b, 204c, and 204d, in a single antenna panel. However, four antenna locations 204a, 204b, 204c, and 204d are arranged in two rows and two columns, and, accordingly, the second antenna architecture 204 may be presented using N_{g}=1, N₁=2, and N₂=2, such as (1, 2, 2).

A third antenna architecture 206 includes two antenna panels 208 and 210, and each antenna panel includes two antenna locations. For example, an antenna panel 208 includes two antenna panels 208a and 208b arranged in a horizonal direction, and an antenna panel 210 includes two antenna locations 210a and 210b arranged in a horizonal direction. The third antenna architecture 206 may, therefore, be represented using N_{g}=2, N₁=2, and N₂=1, such as (2, 2, 1).

Accordingly, in other words, an antenna panel corresponds with an antenna port group. Thus, each of antenna architectures 202 and 204 is a single-panel (SP) antenna architecture, and an antenna architecture 206 is a multi-panel (MP) antenna architecture.

A fourth antenna architecture 212 includes four antenna panels 214, 216, 218, and 220, each including a single antenna location 214a, 216a. 218a, and 220a, respectively. The fourth antenna architecture 212 may be represented using N_{g}=4, N₁=1, and N₂=1, such as (4, 1, 1). Since a value of N_{g} for the fourth antenna architecture is 4 (or more than 1), the fourth antenna architecture is also an MP antenna architecture, as described herein.

In some embodiments, a UE may report or indicate to a network device (e.g., in a RAN or a CN), via a radio resource control (RRC) signaling and/or a MAC control element (MAC CE), that the UE supports a codebook based coherent PUSCH operation using 8 antenna ports, and also an antenna architecture that supports the codebook based coherent PUSCH operation using 8 antenna ports. An antenna architecture of 8 antenna ports may be represented with (N_{g}, N₁, N₂) of, including but not limited to, (1, 4, 1), (1, 2, 2), (2, 2, 1) or (4, 1, 1). By way of a non-limiting example, the UE may report the antenna architecture that supports the codebook based coherent PUSCH operation using 8 antenna ports. For example, when the UE supports partial-coherent PUSCH operation, which maps to a coherency mode of partial-coherent, and/or when the UE supports coherent PUSCH operation, which maps to a coherency mode of full-coherent, as described herein, the UE may report an antenna architecture supported by the UE to the network device. In some embodiments, when the UE indicates that the UE supports coherent PUSCH operation, which maps to a coherency mode of partial-coherent and/or full-coherent, the network device may configure a UL TPMI codebook, for the codebook based PUSCH operation, for at least one of: two antenna ports or four antenna ports of the antenna architecture of the UE two or four antenna ports. The UE is expected to support and honor configured TPMI codebook for the coherent PUSCH operation.

In some embodiments, when a network device configures a UE for codebook based coherent PUSCH operation using, for example, 8 antenna ports, the network device may or may not configure a UE also for the UE antenna architecture, which may imply a different TPMI codebook for the codebook based PUSCH operation. A TPMI codebook for the codebook based PUSCH operation is determined based on the antenna architecture reported by the UE. Codebook based coherent PUSCH operation may refer to a coherency mode of partial-coherent and/or full-coherent, as described herein.

In some embodiments, a codebook for an UL TPMI may be based on a Type I downlink (DL) codebook, and the UL TPMI may be based on a Type I SP codebook and/or a Type I MP codebook. When the UL TPMI can be based on Type I SP codebook and Type I MP codebook both, a UE may explicitly and/or independently report or transmit to a network device whether the UE supports the Type I SP codebook or the Type I MP codebook for the UL TPMI. In some embodiments, whether the UE supports Type I SP codebook or Type I MP codebook for the UL TPMI may be determined by the network device implicitly, e.g., based on the antenna architecture of the UE indicated by the UE as a UE capability to the network device. Accordingly, when the network device receives in a UE capability that the UE supports the first antenna architecture or the second antenna architecture described herein using FIG. 2, the network device may determine that the UE supports the Type I SP codebook for the UL TPMI, and when the network device receives in a UE capability that the UE supports the third antenna architecture or the fourth antenna architecture described herein using FIG. 2, the network device may determine that the UE supports Type I MP codebook for the UL TPMI. In some embodiments, the UE may report either the Type I SP codebook or the Type I MP codebook, but not both. In some embodiments, the UE may support at least the Type I SP codebook for the UL TPMI. A network device may configure the UE for the UL TPMI codebook, which may be the Type I SP codebook or the Type I MP codebook using RRC signaling, a MAC CE. By way of an example, a network device may dynamically update the UL TPMI codebook, for example, using DCI. The Type I SP codebook and/or the Type I MP codebook described herein may be a sub-band Type I codebook or a wideband Type I codebook.

In some embodiments, when the Type I SP codebook and/or the Type I MP codebook is used for the UL TPMI codebook, and whether the UL TPMI codebook is the Type 1 SP codebook or the Typ1 1 MP codebook is not indicated in the DCI, a size of “precoding information and number of layers” field in DCI used for scheduling the PUSCH may be

$$[ log 2 ( {\sum }_{l = 1}^{Lmax} Nl ) ] ,$$

where Lₘₐₓ corresponds to a maximum number of ranks configured by RRC, Nl corresponds with a number of different precoding matrix supported by the UL TPMI codebook of type I (or the Type I codebook), and l may correspond with values 1, 2, . . . , 8 with an antenna architecture of 8 antenna ports.

In some embodiments, a table below may be used for mapping of “precoding information and number of layers” field to a particular TPMI.

| Value of “Precoding | |
|---|---|
| information and number | |
| of layers” field in DCI | Mapped TPMI |
| 0 to N1 − 1 | Type I codebook for rank 1 with 8 ports |
| N1 to N1 + N2 − 1 | Type I codebook for rank 2 with 8 ports |
| . . . | . . . |
| N1 + N2 + . . . + N7 to | Type I codebook for rank 8 with 8 ports |
| N1 + N2 + . . . + N8 − 1 | |

In some embodiments, when the Type I SP codebook and/or Type I MP codebook is used for the UL TPMI codebook, and whether the UL TPMI codebook is the Type 1 SP codebook or the Typ1 1 MP codebook is indicated in the DCI, the Type I SP codebook and the Type I MP codebook may be concatenated in the “precoding information and a number of layers” field in DCI used for scheduling PUSCH operation. Accordingly, a size of the “precoding information and a number of layers” field in DCI may be

$$[ log 2 ( ( {\sum }_{l = 1}^{Lmax} Nl ) SP + ( {\sum }_{l = 1}^{Lmax} Nl ) MP ) ] .$$

In some embodiments, and by way of a non-limiting example, an additional bit in the field the “precoding information and a number of layers” field in DCI may be used to indicate whether the UL TPMI is a Type I SP codebook or a Type I MP codebook. Accordingly, a size of the “precoding information and a number of layers” field in DCI may be of

$$max \{ [ log 2 ( ( {\sum }_{l = 1}^{Lmax} Nl ) SP ) ] , [ log 2 ( ( {\sum }_{l = 1}^{Lmax} Nl ) MP ) ] \} .$$

In some embodiments, and by way of a non-limiting example, to reduce overhead of a TPMI indication, for example, a possible number of TPMI(s), a rotation factor (or an oversampling factor) in one or both of vertical polarization and horizontal polarization of cross polarized antenna elements of the antenna architecture of the UE may be reduced from 4 to 2, or 4 to 1. Additionally, or alternatively, the overhead of the TPMI indication may be reduced by reducing quantization bits used for co-phasing of a polarization of antenna elements of the antenna architecture of the UE, and/or reducing selection for an orthogonal layer on a spatial basis, the orthogonal layer is not a first layer.

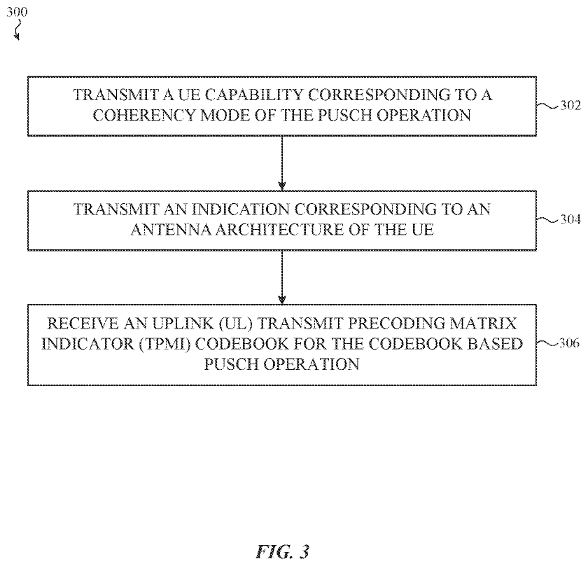

FIG. 3 shows an example method of wireless communication performed by a user equipment (UE), according to embodiments described herein. As shown in a flow-chart 300, at 302, a UE may transmit, to a network device, a UE capability corresponding to a coherency mode of a codebook based PUSCH operation. The coherency mode may be one of: a non-coherent mode, a full-coherent mode, and a partial-coherent mode, and may be transmitted to the network device as a UE capability using RRC and/or MAC CE. At 304, the UE may transmit to the network device an indication of an antenna architecture supported by the UE. The antenna architecture may be based on at least partly on a number of antenna ports, and their corresponding arrangement, as shown in FIG. 2. Further, as described herein, the UE may transmit an indication of the antenna architecture supported by the UE based on a UE capability corresponding to the coherency mode supported by the UE. At 306, the UE may receive, from the network device, an uplink (UL) transmit precoding matrix indicator (TPMI) codebook for the codebook based PUSCH operation. The TPMI codebook is determined by the network device, as described herein, based on the antenna architecture of the UE as indicated to the network device by the UE.

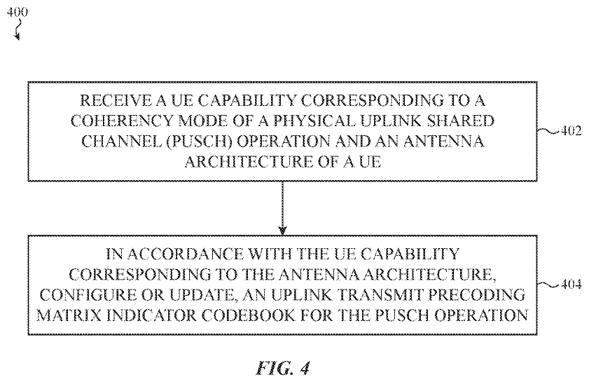

FIG. 4 shows an example method of wireless communication performed by a network device, according to embodiments described herein. A network device may a network device, for example, a base station in a RAN, or a server in a CN. As shown in a flow-chart 400, at 402, a network device may receive a UE capability corresponding to a coherency mode of a PUSCH operation and/or an antenna architecture of a UE. The UE capability corresponding to the coherency mode of the PUSCH operation and/or the antenna architecture of the UE may be received via RRC signaling or a MAC CE. At 404, the network device may configure or update the UE with a TPMI codebook for the PUSCH operation. The TPMI codebook may be configured or updated using RRC signaling, a MAC CE, and/or DCI. Since details of various antenna architectures, coherency modes, and selecting a TPMI codebook based on the coherency modes and/or antenna architectures are described in detail, those details are not repeated here for brevity.

Embodiments contemplated herein include an apparatus having logic, modules, or circuitry to perform one or more elements of the method 300 or 400. In the context of method 300, the apparatus may be, for example, an apparatus of a UE (such as a wireless device 602 that is a UE, as described herein). In the context of method 400, the apparatus may be, for example, a network device (such as a network device 620, which may be a base station, as described herein).

Embodiments contemplated herein include an apparatus having one or more processors and one or more computer-readable media, using or storing instructions that, when executed by the one or more processors, cause the one or more processors to perform one or more elements of the method 300 or 400. In the context of method 300, the apparatus may be, for example, an apparatus of a UE (such as a wireless device 602 that is a UE, as described herein). In the context of the method 400, the apparatus may be, for example, a network device (such as a network device 620, which may be a base station, as described herein).

Embodiments contemplated herein include a signal as described in or related to one or more elements of the method 300 or 400.

Embodiments contemplated herein include a computer program or computer program product having instructions, wherein execution of the program by a processor causes the processor to carry out one or more elements of the method 300 or 400. In the context of method 300, the processor may be a processor of a UE (such as a processor(s) 604 of a wireless device 602 that is a UE, as described herein), and the instructions may be, for example, located in the processor and/or on a memory of the UE (such as a memory 606 of a wireless device 602 that is a UE, as described herein). In the context of method 600, the processor may be a processor of a base station (such as a processor(s) 622 of a network device 620 that is a base station, as described herein), and the instructions may be, for example, located in the processor and/or on a memory of the base station (such as a memory 624 of a network device 620 that is a base station, as described herein).

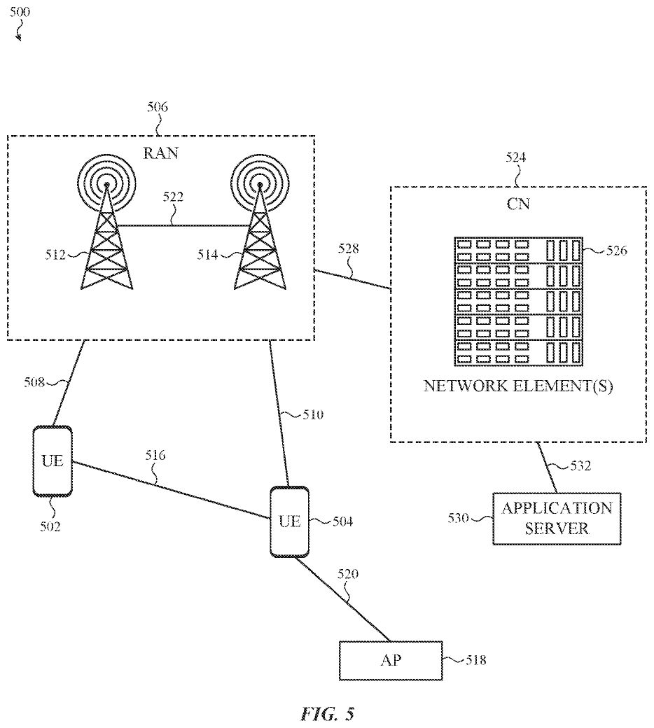

FIG. 5 illustrates an example architecture of a wireless communication system 500, according to embodiments disclosed herein. The following description is provided for an example wireless communication system 500 that operates in conjunction with the LTE system standards and/or 5G or NR system standards as provided by 3GPP technical specifications.

As shown by FIG. 5, the wireless communication system 500 includes UE 502 and UE 504 (although any number of UEs may be used). In this example, the UE 502 and the UE 504 are illustrated as smartphones (e.g., handheld touchscreen mobile computing devices connectable to one or more cellular networks), but may also comprise any mobile or non-mobile computing device configured for wireless communication.

The UE 502 and UE 504 may be configured to communicatively couple with a RAN 506. In embodiments, the RAN 506 may be NG-RAN, E-UTRAN, etc. The UE 502 and UE 504 utilize connections (or channels) (shown as connection 508 and connection 510, respectively) with the RAN 506, each of which comprises a physical communications interface. The RAN 506 can include one or more base stations, such as base station 512 and base station 514, that enable the connection 508 and connection 510.

In this example, the connection 508 and connection 510 are air interfaces to enable such communicative coupling, and may be consistent with RAT(s) used by the RAN 506, such as, for example, an LTE and/or NR.

In some embodiments, the UE 502 and UE 504 may also directly exchange communication data via a sidelink interface 516. The UE 504 is shown to be configured to access an access point (shown as AP 518) via connection 520. By way of example, the connection 520 can comprise a local wireless connection, such as a connection consistent with any IEEE 802.11 protocol, wherein the AP 518 may comprise a Wi-Fi® router. In this example, the AP 518 may be connected to another network (for example, the Internet) without going through a CN 524.

In embodiments, the UE 502 and UE 504 can be configured to communicate using orthogonal frequency division multiplexing (OFDM) communication signals with each other or with the base station 512 and/or the base station 514 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 512 or base station 514 may be implemented as one or more software entities running on server computers as part of a virtual network. In addition, or in other embodiments, the base station 512 or base station 514 may be configured to communicate with one another via interface 522. In embodiments where the wireless communication system 500 is an LTE system (e.g., when the CN 524 is an EPC), the interface 522 may be an X2 interface. The X2 interface may be defined between two or more base stations (e.g., two or more eNBs and the like) that connect to an EPC, and/or between two eNBs connecting to the EPC. In embodiments where the wireless communication system 500 is an NR system (e.g., when CN 524 is a 5GC), the interface 522 may be an Xn interface. The Xn interface is defined between two or more base stations (e.g., two or more gNBs and the like) that connect to 5GC, between a base station 512 (e.g., a gNB) connecting to 5GC and an eNB, and/or between two eNBs connecting to 5GC (e.g., CN 524).

The RAN 506 is shown to be communicatively coupled to the CN 524. The CN 524 may comprise one or more network elements 526, which are configured to offer various data and telecommunications services to customers/subscribers (e.g., users of UE 502 and UE 504) who are connected to the CN 524 via the RAN 506. The components of the CN 524 may be implemented in one physical device or separate physical devices including components to read and execute instructions from a machine-readable or computer-readable medium (e.g., a non-transitory machine-readable storage medium).

In embodiments, the CN 524 may be an EPC, and the RAN 506 may be connected with the CN 524 via an S1 interface 528. In embodiments, the S1 interface 528 may be split into two parts, an S1 user plane (S1-U) interface, which carries traffic data between the base station 512 or base station 514 and a serving gateway (S-GW), and the S1-MME interface, which is a signaling interface between the base station 512 or base station 514 and mobility management entities (MMEs).

In embodiments, the CN 524 may be a 5GC, and the RAN 506 may be connected with the CN 524 via an NG interface 528. In embodiments, the NG interface 528 may be split into two parts, an NG user plane (NG-U) interface, which carries traffic data between the base station 512 or base station 514 and a user plane function (UPF), and the S1 control plane (NG-C) interface, which is a signaling interface between the base station 512 or base station 514 and access and mobility management functions (AMFs).

Generally, an application server 530 may be an element offering applications that use internet protocol (IP) bearer resources with the CN 524 (e.g., packet switched data services). The application server 530 can also be configured to support one or more communication services (e.g., VOIP sessions, group communication sessions, etc.) for the UE 502 and UE 504 via the CN 524. The application server 530 may communicate with the CN 524 through an IP communications interface 532.

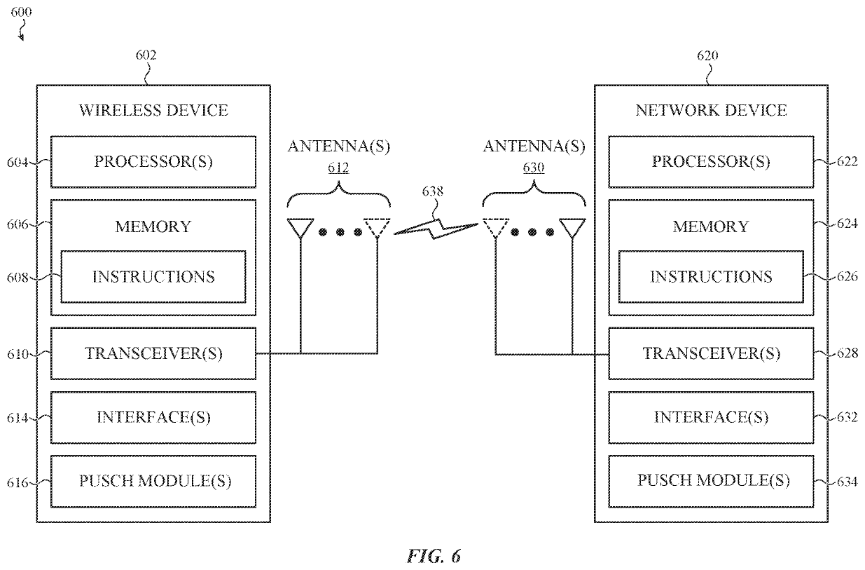

FIG. 6 illustrates a system 600 for performing signaling 638 between a wireless device 602 and a network device 620, according to embodiments disclosed herein. The system 600 may be a portion of a wireless communication system as herein described. The wireless device 602 may be, for example, a UE of a wireless communication system. The network device 620 may be, for example, a base station (e.g., an eNB or a gNB) of a wireless communication system.

The wireless device 602 may include one or more processor(s) 604. The processor(s) 604 may execute instructions such that various operations of the wireless device 602 are performed, as described herein. The processor(s) 604 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 602 may include a memory 606. The memory 606 may be a non-transitory computer-readable storage medium that stores instructions 608 (which may include, for example, the instructions being executed by the processor(s) 604). The instructions 608 may also be referred to as program code or a computer program. The memory 606 may also store data used by, and results computed by, the processor(s) 604.

The wireless device 602 may include one or more transceiver(s) 610 that may include radio frequency (RF) transmitter and/or receiver circuitry that use the antenna(s) 612 of the wireless device 602 to facilitate signaling (e.g., the signaling 640) to and/or from the wireless device 602 with other devices (e.g., the network device 620) according to corresponding RATs.

The wireless device 602 may include one or more antenna(s) 612 (e.g., one, two, four, or more). For embodiments with multiple antenna(s) 612, the wireless device 602 may leverage the spatial diversity of such multiple antenna(s) 612 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 602 may be accomplished according to precoding (or digital beamforming) that is applied at the wireless device 602 that multiplexes the data streams across the antenna(s) 612 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multiuser MIMO (MU-MIMO) methods (where individual data streams may be directed to individual (different) receivers in different locations in the spatial domain).

In certain embodiments having multiple antennas, the wireless device 602 may implement analog beamforming techniques, whereby phases of the signals sent by the antenna(s) 612 are relatively adjusted such that the (joint) transmission of the antenna(s) 612 can be directed (this is sometimes referred to as beam steering).

The wireless device 602 may include one or more interface(s) 614. The interface(s) 614 may be used to provide input to or output from the wireless device 602. For example, a wireless device 602 that is a UE may include interface(s) 614 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 610/antenna(s) 612 already described) that allow for communication between the UE and other devices and may operate according to known protocols (e.g., Wi-Fi®, Bluetooth®, and the like).

The wireless device 602 may include one or more modules for physical uplink shared channel transmission shown as PUSCH module(s) 616. The PUSCH module(s) 616 may be implemented via hardware, software, or combinations thereof. For example, the PUSCH module(s) 616 may be implemented as a processor, circuit, and/or instructions 608 stored in the memory 606 and executed by the processor(s) 604. In some examples, the PUSCH module(s) 616 may be integrated within the processor(s) 604 and/or the transceiver(s) 610. For example, the CSI measurement and reporting module(s) 616 may be implemented by a combination of software components (e.g., executed by a DSP or a general processor) and hardware components (e.g., logic gates and circuitry) within the processor(s) 604 or the transceiver(s) 610.

The PUSCH module(s) 616 may be used for various aspects of the present disclosure, for example, aspects of FIGS. 1-4. The PUSCH module(s) 616 may be configured to, for example, configure CSI measurement and reporting and transmit one or more CSI reports to another device (e.g., to the network device 620).

The network device 620 may include one or more processor(s) 622. The processor(s) 622 may execute instructions such that various operations of the network device 620 are performed, as described herein. The processor(s) 604 may include one or more baseband processors implemented using, for example, a CPU, a DSP, an ASIC, a controller, an FPGA device, another hardware device, a firmware device, or any combination thereof configured to perform the operations described herein.

The network device 620 may include a memory 624. The memory 624 may be a non-transitory computer-readable storage medium that stores instructions 626 (which may include, for example, the instructions being executed by the processor(s) 622). The instructions 626 may also be referred to as program code or a computer program. The memory 624 may also store data used by, and results computed by, the processor(s) 622.

The network device 620 may include one or more transceiver(s) 628 that may include RF transmitter and/or receiver circuitry that use the antenna(s) 630 of the network device 620 to facilitate signaling (e.g., the signaling 640) to and/or from the network device 620 with other devices (e.g., the wireless device 602) according to corresponding RATs.

The network device 620 may include one or more antenna(s) 630 (e.g., one, two, four, or more). In embodiments having multiple antenna(s) 630, the network device 620 may perform MIMO, digital beamforming, analog beamforming, beam steering, etc., as has been described.

The network device 620 may include one or more interface(s) 632. The interface(s) 632 may be used to provide input to or output from the network device 620. For example, a network device 620 that is a base station may include interface(s) 632 made up of transmitters, receivers, and other circuitry (e.g., other than the transceiver(s) 628/antenna(s) 630 already described) that enables the base station to communicate with other equipment in a core network, and/or that enables the base station to communicate with external networks, computers, databases, and the like for purposes of operations, administration, and maintenance of the base station or other equipment operably connected thereto.

The network device 620 may include one or more modules for physical uplink shared channel transmission shown as PUSCH module(s) 634. The PUSCH module(s) 634 may be implemented via hardware, software, or combinations thereof. For example, the PUSCH module(s) 634 may be implemented as a processor, circuit, and/or instructions 626 stored in the memory 624 and executed by the processor(s) 622. In some examples, the PUSCH module(s) 634 may be integrated within the processor(s) 622 and/or the transceiver(s) 628. For example, the PUSCH module(s) 634 may be implemented by a combination of software components (e.g., executed by a DSP or a general processor) and hardware components (e.g., logic gates and circuitry) within the processor(s) 622 or the transceiver(s) 628.

The PUSCH module(s) 634 may be used for various aspects of the present disclosure, for example, aspects of FIGS. 1-4, from a network device perspective.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

We claim:

1. A user equipment (UE), comprising:
a transceiver associated with a set of antenna ports; and
a processor configured to:
transmit, to a network device and via the transceiver, a UE capability corresponding to a coherency mode of a codebook based physical uplink shared channel (PUSCH) operation;
transmit, to the network device and via the transceiver, an indication of an antenna architecture of the UE, the antenna architecture based at least partly on the set of antenna ports; and
receive, from the network device and via the transceiver, an uplink (UL) transmit precoding matrix indicator (TPMI) codebook for the codebook based PUSCH operation, in accordance with the coherency mode and the antenna architecture of the UE indicated to the network device.

2. The UE of claim 1, wherein the set of antenna ports includes at least eight antenna ports.

3. The UE of claim 1, wherein the coherency mode is one of: a non-coherent mode, a full-coherent mode, and a partial-coherent mode.

4. The UE of claim 3, wherein the indication of the antenna architecture of the UE is transmitted for the coherency mode of the full-coherent mode or the partial-coherent mode.

5. The UE of claim 1, wherein:
the antenna architecture of the UE is parameterized using at least,
a first parameter that corresponds with a number of antenna port groups;
a second parameter that corresponds with a number of antenna locations in a vertical direction; and
a third parameter that corresponds with a number of antenna locations in a horizontal direction.

6. The UE of claim 5, wherein the first parameter has a value that indicates the antenna architecture of the UE is a single-panel (SP) antenna architecture.

7. The UE of claim 5, wherein the first parameter has a value that indicates the antenna architecture of the UE is a multi-panel (MP) antenna architecture.

8. The UE of claim 5, wherein:
a value of the first parameter is at least any one of: 1, 2, and 4;
a value of the second parameter is at least any one of: 1, 2, and 4; and
a value of the third parameter is at least any one of: 1 and 2.

9. The UE of claim 8, wherein a value of the second parameter is 4 and a value of the third parameter is 1.

10. The UE of claim 8, wherein a value of the second parameter is 2 and a value of the third parameter is 2.

11. The UE of claim 5, wherein the UL TPMI codebook for the codebook based PUSCH operation is received at the UE from the network device via radio resource control (RRC) signaling.

12. The UE of claim 11, wherein the processor is further configured to receive, from the network device and via the transceiver, the UL TPMI for the codebook based PUSCH operation for four antenna ports of the antenna architecture of the UE.

13. The UE of claim 12, wherein the processor is further configured to receive, from the network device and via the transceiver, a configuration of the antenna architecture of the UE.

14. The UE of claim 12, wherein:
the UL TPMI codebook for the codebook based PUSCH operation is based on a downlink (DL) codebook;
the DL codebook is a Type 1 DL codebook; and
the UL TPMI codebook is a Type 1 single-panel (SP) codebook that corresponds with a single-panel (SP) antenna architecture.

15. A method for performing a physical uplink shared channel (PUSCH) operation using a plurality of transmitters including at least eight transmitters, comprising:
determining, by a user equipment (UE) a coherency mode of the PUSCH operation;
transmitting, from the UE to a network device, a UE capability corresponding to the coherency mode of the PUSCH operation;
transmitting, from the UE to the network device, an indication corresponding to an antenna architecture of the UE;
determining an uplink (UL) transmit precoding matrix indicator (TPMI) codebook for the PUSCH operation in accordance with the coherency mode and a UE capability corresponding to the antenna architecture of the UE; and
in accordance with the determining of the UL TPMI codebook, transmitting, from the UE to the network device, an indication corresponding to the determined UL TPMI codebook.

16. The method of claim 15, wherein the set of antenna ports includes at least eight antenna ports.

17. The method of claim 15, wherein the coherency mode is one of: a non-coherent mode, a full-coherent mode, and a partial-coherent mode.

18. The method of claim 15, wherein:
the antenna architecture of the UE is parameterized using at least,
a first parameter that corresponds with a number of antenna port groups;
a second parameter that corresponds with a number of antenna locations in a vertical direction; and
a third parameter that corresponds with a number of antenna locations in a horizontal direction.

19. The UE of claim 8, wherein:
a value of the second parameter is 4 and a value of the third parameter is 1; or
a value of the second parameter is 2 and a value of the third parameter is 2.

20. A network device, comprising:
a transceiver; and
a processor configured to:
receive, via the transceiver and from a user equipment (UE),
a UE capability corresponding to a coherency mode of a codebook based physical uplink shared channel (PUSCH) operation using a plurality of transmitters and a single-panel or a multi-panel antenna architecture of the UE; and
an antenna architecture of the UE in accordance with the UE capability corresponding to the coherency mode of a PUSCH operation and the codebook based PUSCH operation; and
in accordance with the UE capability corresponding to the antenna architecture, configure or update, an uplink (UL) transmit precoding matrix indicator (TPMI) codebook for the PUSCH operation using a radio resource control (RRC) signaling.
